(19) United States
(12) Patent Application Publication
(10) Pub. No.: US 2010/0131967 A1
(43) Pub. Date: May 27, 2010

(54) STORAGE MEDIUM CHANGER

(76) Inventor: Yoshitaka Nakamura, Tokyo (JP)

Correspondence Address: BIRCH STEWART KOLASCH & BIRCH, PO BOX 747, FALLS CHURCH, VA, 22040-0747, US

(21) Appl. No.: 12/598,148

(22) PCT Filed: Mar. 3, 2008
(86) PCT No.: PCT/JP2008/000424

§ 371 Date: Oct. 29, 2009

(30) Foreign Application Priority Data
Jul. 3, 2007 (JP) 2007-175442

(51) Int. Cl. G11B 17/04

(52) U.S. Cl. 720/615; G9B/17.013

(57) ABSTRACT

Characterized by checking, after stopping a stocker driving motor, whether a target pattern can be detected at the stopping position or not; and by reducing, if the target pattern cannot be detected at the stopping position, the driving force of the stocker driving motor during retrying operation carried out by reversing the rotation of the stocker driving motor.

### TECHNICAL FIELD

The present invention relates to a storage medium changer for changing a storage medium by moving a stocker that contains storage mediums to a changing position.

### BACKGROUND ART

FIG. 8 is a block diagram showing a configuration of a conventional storage medium changer which has a disk stocker (stocker) 1 for containing disks 2 that are storage mediums; a stocker elevating section 3 for moving the disk stocker 1 up and down; a stocker driving motor 4 for driving the stocker elevating section 3; a position detecting section 5 having a slit that changes its pattern in accordance with the position of the stocker elevating section 3; a photo-interrupter (slit detecting section) 6 for optically detecting the pattern of the slit of the position detecting section 5; a microcomputer 7 for controlling the whole storage medium changer in response to a request for changing the disk 2; and a driver 8 for carrying out power amplification of the output signal from the microcomputer 7 to the stocker driving motor 4.

In addition, the microcomputer 7 includes a pattern recognition section 71 for recognizing the pattern of the slit output from the photo-interrupter 6; a memory 72 for storing the pattern of the slit of the position detecting section 5 and the position of the stocker elevating section 3 with the correspondence between them; a pattern comparing section 73 for comparing, referring to the memory 72 when a request for changing a disk 2 is made, the pattern of the slit of the position detecting section 5 (target pattern), which will be detected when the stocker elevating section 3 moves to the changing position of the disk 2 for which the request for changing is made, with the pattern of the slit the pattern recognition section 71 recognizes, and for outputting a control signal when the target pattern is detected; an external I/F (interface) 74 for receiving a request for changing the disk 2; a mechanism control section 75 for instructing the operation of the stocker driving motor 4 in response to the change request the external I/F 74 receives; and a motor control section 76 for controlling the stocker driving motor 4 in response to the instruction of the mechanism control section 75.

Next, the operation will be described.

FIG. 9 is a flowchart showing the operation of the conventional storage medium changer. When the external I/F 74 receives a request for changing the disk 2, the mechanism control section 75 refers to the memory 72 in response to the change request received, and sets the pattern of the slit of the position detecting section 5, which will be detected when the stocker elevating section 3 moves to the changing position of the disk 2 for which a request for changing is made, as a target pattern (step ST601). Next, the mechanism control section 75 sets the direction of rotation of the stocker driving motor 4 in accordance with the slit pattern the pattern recognition section 71 recognizes and the target pattern set at step ST601 (step ST602).

Next, the mechanism control section 75 instructs the motor control section 76 to drive the stocker driving motor 4, and the motor control section 76 starts the operation of the stocker driving motor 4 in response to the instruction from the mechanism control section 75 (step ST603). Next, the pattern comparing section 73 compares, throughout the operation of the stocker driving motor 4, the slit pattern recognized by the pattern recognition section 71 with the target pattern, and outputs the control signal when detecting the target pattern (step ST604). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST605) to stop the stocker driving motor 4.

Next, the mechanism control section 75 checks, at the position where the stocker driving motor 4 stops, whether the control signal is output from the pattern comparing section 73 (step ST606). If the control signal is output from the pattern comparing section 73 at step ST606, the mechanism control section 75 completes its operation. Unless the control signal is output from the pattern comparing section 73 at step ST606, the mechanism control section 75 considers that the stocker elevating section 3 overruns the position of the target pattern set at step ST601, reverses the direction of rotation of the stocker driving motor 4 (step ST607), repeats the operation from step ST603 again, and repeats the operation from step ST603 to step ST607 until the control signal is output from the pattern comparing section 73 at step ST606.

In addition, there is a conventional storage medium changer with a configuration which provides, to stop the disk stocker 1 accurately at the changing position of the disk 2, the disk stocker 1 with triangular windows at the same spacing as the holding spacing of the disks 2; provides a photo-interrupter to a stationary component remaining at rest with respect to the disk stocker 1 in such a manner that a light-emitting element and a photodetector face via one of the windows, and that the amount of light the photodetector receives through the window varies depending on which position the photo-interrupter is placed with respect to the window; and stops the disk stocker 1 at the position at which the photodetector receives the maximum amount of light, that is, at the position at which the photo-interrupter comes to the center of the window (see Patent Document 1, for example).

Patent Document 1: Japanese Patent Laid-Open No. 10-308054/1998.

As described above, the conventional storage medium changer instructs the stocker driving motor 4 to stop after detecting the target pattern. However, the stocker driving motor 4 cannot stop immediately when it receives the stop instruction, and hence an idle running distance occurs, which causes a difference between the detection position of the target pattern and the actual stopping position of the stocker elevating section 3. Thus, design considering the idle running distance is desired. However, within the limited space such as the storage medium changer, the design considering the idle running distance cannot be achieved, and accuracy is required for the stopping position. Accordingly, it makes a decision, after the stocker driving motor 4 stops, as to whether the target pattern has been detected at the stopping position or not, and if the target pattern has not been detected at the stopping position, it reverses the rotation of the stocker driving motor 4 and carries out the foregoing operation until the target pattern is detected at the stopping position (referred to as “retrying operation” from now on).

However, when the load of the stocker driving motor 4 is light, the operation speed of the stocker elevating section 3 becomes high, and the idle running distance increases naturally, which offers a problem in that the retrying operation occurs frequently. On the contrary, when the voltage applied to the stocker driving motor 4 is set at a low level, that is, when the driving force is set at a low level to reduce the idle running distance, a problem arises of taking a lot of time to arrive at the changing position if the load of the stocker driving motor 4 is high. As for the device providing the triangular windows to the disk stocker 1, besides the foregoing problems, it requires a certain accuracy for forming the triangular windows, and hence presents a problem of increasing the cost of manufacturing.

The present invention is implemented to solve the foregoing problems. Therefore it is an object of the present invention to stop the stocker elevating section for moving the stocker that contains storage mediums up and down at a prescribed position accurately, thereby preventing the delay due to the retrying operation.

### DISCLOSURE OF THE INVENTION

A storage medium changer in accordance with the present invention is characterized by checking, after stopping a stocker driving motor, whether a target pattern can be detected at the stopping position or not; and by reducing, if the target pattern cannot be detected at the stopping position, the driving force of the stocker driving motor during retrying operation carried out by reversing the rotation of the stocker driving motor.

According to the present invention, it is configured in such a manner as to check, after stopping a stocker driving motor, whether a target pattern can be detected at the stopping position or not; and to reduce, if the target pattern cannot be detected at the stopping position, the driving force of the stocker driving motor during retrying operation carried out by reversing the rotation of the stocker driving motor. Accordingly, it offers an advantage of being able to stop the stocker elevating section, which moves the stocker containing storage mediums up and down, at the prescribed position accurately, and to prevent the delay due to the retrying operation.

### BRIEF DESCRIPTION OF THE DRAWINGS

FIG. 1 is a block diagram showing a configuration of a storage medium changer of an embodiment 1;

FIG. 2 is a flowchart showing the operation of the storage medium changer of the embodiment 1;

FIG. 3 is a flowchart showing the operation of the storage medium changer of an embodiment 2;

FIG. 4 is a flowchart showing the operation of the storage medium changer of an embodiment 3;

FIG. 5 is a flowchart showing the operation of the storage medium changer of an embodiment 4;

FIG. 6 is a block diagram showing a configuration of the storage medium changer of an embodiment 5;

FIG. 7 is a flowchart showing the operation of the storage medium changer of the embodiment 5;

FIG. 8 is a block diagram showing a configuration of a conventional storage medium changer; and

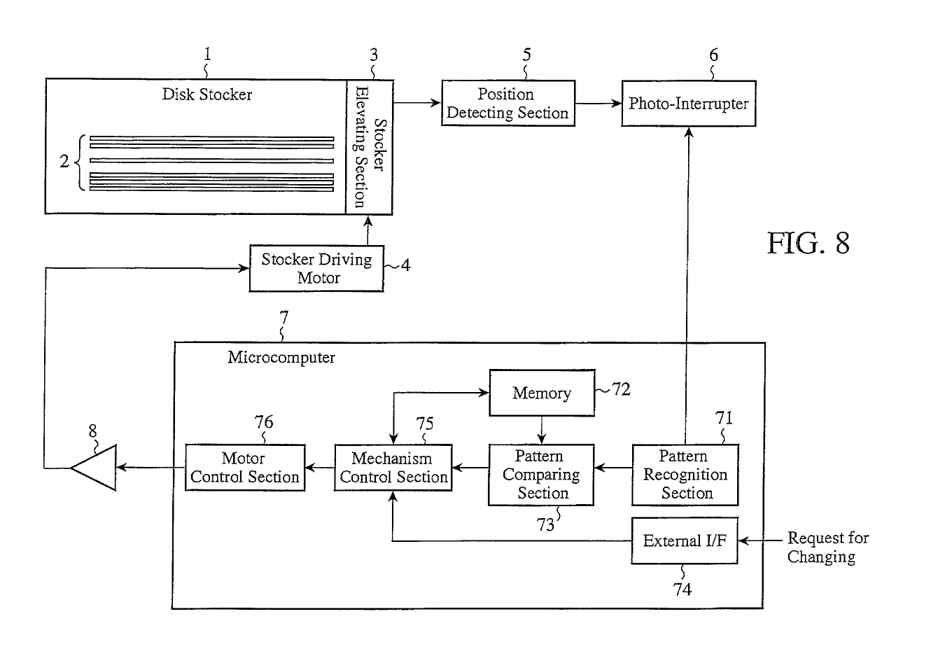

FIG. 9 is a flowchart showing the operation of the conventional storage medium changer.

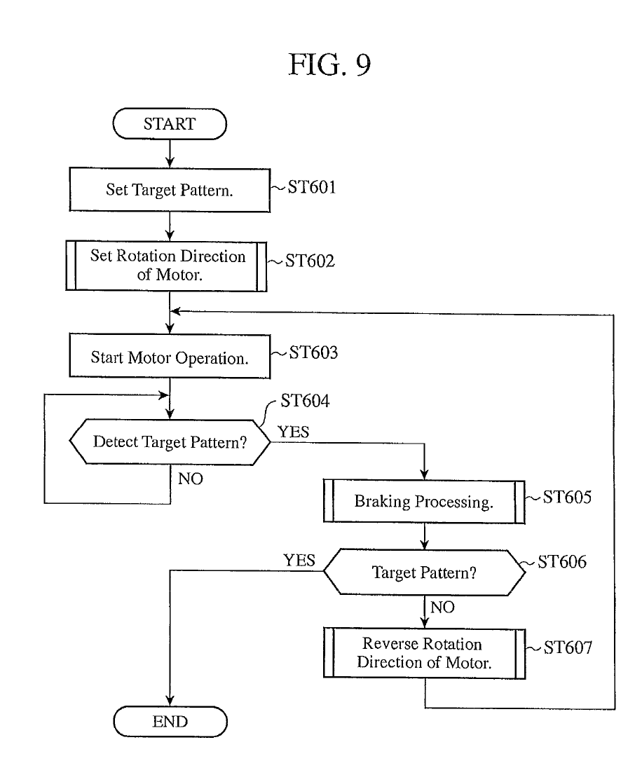

### BEST MODE FOR CARRYING OUT THE INVENTION

In the following, embodiments in accordance with the invention will now be described with reference to the accompanying drawings.

### Embodiment 1

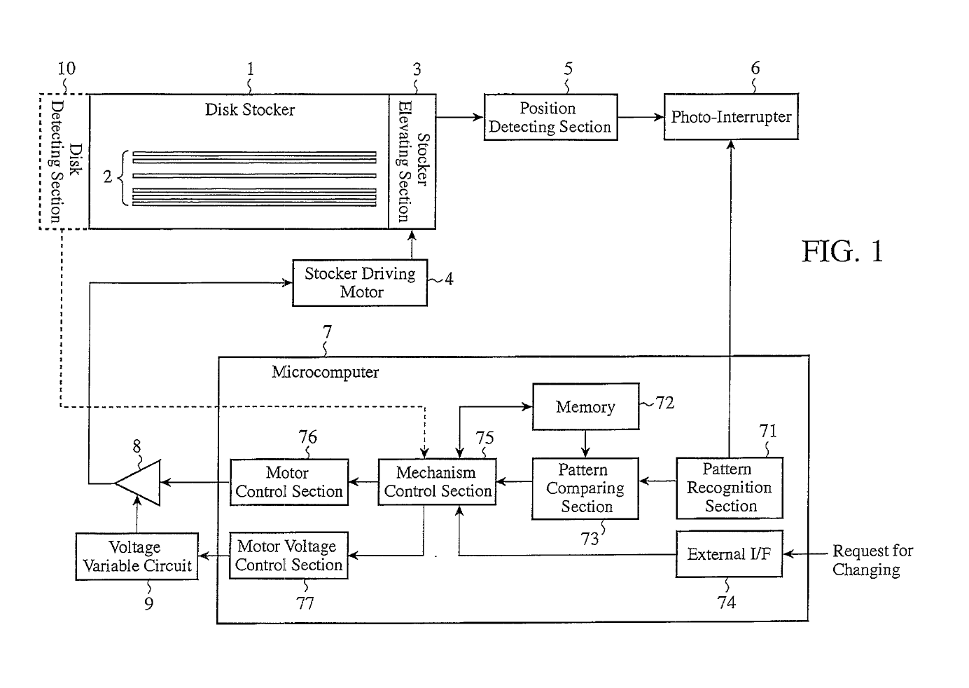

FIG. 1 is a block diagram showing a configuration of a storage medium changer of an embodiment 1. The storage medium changer of the embodiment 1 has a disk stocker (stocker) 1 for containing disks 2 (storage mediums); a stocker elevating section 3 for moving the disk stocker 1 up and down; a stocker driving motor 4 for driving the stocker elevating section 3; a position detecting section 5 having a slit that changes its pattern in accordance with the position of the stocker elevating section 3; a photo-interrupter (slit detecting section) 6 for optically detecting the pattern of the slit of the position detecting section 5; a microcomputer 7 for controlling the whole storage medium changer in response to a request for changing the disk 2; a driver 8 for carrying out power amplification of the output signal from the microcomputer 7 to the stocker driving motor 4; and a voltage variable circuit 9 for controlling the amplification factor of the driver 8.

In addition, the microcomputer 7 includes a pattern recognition section 71 for recognizing the pattern of the slit output from the photo-interrupter 6; a memory 72 for storing the pattern of the slit of the position detecting section 5 and the position of the stocker elevating section 3 with the correspondence between them; a pattern comparing section 73 for comparing, referring to the memory 72 when a request for changing the disk 2 is made, the pattern of the slit of the position detecting section 5 (target pattern), which will be detected when the stocker elevating section 3 moves to the changing position of the disk 2 for which the request for changing is made, with the pattern of the slit the pattern recognition section 71 recognizes, and for outputting a control signal when the target pattern is detected; an external I/F (interface) 74 for receiving a request for changing the disk 2; a mechanism control section 75 for instructing the operation of the stocker driving motor 4 in response to the change request the external I/F 74 receives; a motor control section 76 for controlling the stocker driving motor 4 in response to the instruction of the mechanism control section 75; and a motor voltage control section 77 for carrying out the control of the voltage variable circuit 9 in response to the instruction of the mechanism control section 75.

Next, the operation will be described.

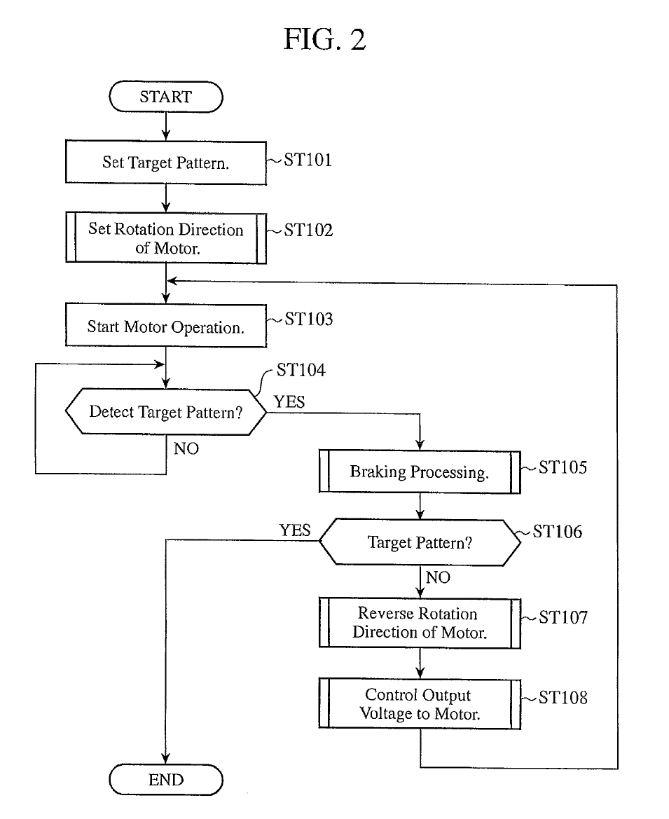

FIG. 2 is a flowchart showing the operation of the storage medium changer of the present embodiment 1. When the external I/F 74 receives a request for changing the disk 2, the mechanism control section 75 refers to the memory 72 in response to the change request received, and sets the pattern of the slit of the position detecting section 5, which will be detected when the stocker elevating section 3 moves to the changing position of the disk 2 for which a request for changing is made, as a target pattern (step ST101). Next, the mechanism control section 75 sets the direction of rotation of the stocker driving motor 4 in accordance with the slit pattern the pattern recognition section 71 recognizes and the target pattern set at step ST101 (step ST102).

Next, the mechanism control section 75 instructs the motor control section 76 to drive the stocker driving motor 4, and the motor control section 76 starts the operation of the stocker driving motor 4 in response to the instruction from the mechanism control section 75 (step ST103). Next, the pattern comparing section 73 compares, throughout the operation of the stocker driving motor 4, the slit pattern recognized by the pattern recognition section 71 with the target pattern, and outputs the control signal when detecting the target pattern (step ST104). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST105) to stop the stocker driving motor 4.

Next, the mechanism control section 75 checks, at the position where the stocker driving motor 4 stops, whether the control signal is output from the pattern comparing section 73 (step ST106). If the control signal is output from the pattern comparing section 73 at step ST106, the mechanism control section 75 completes its operation. Unless the control signal is output from the pattern comparing section 73 at step ST106, the mechanism control section 75 considers that the stocker elevating section 3 overruns the position of the target pattern set at step ST101, reverses the direction of rotation of the stocker driving motor 4 (step ST107), sets the applied voltage at a lower level (step ST108) to reduce the driving force, then repeats the operation from step ST103 again, and repeats the operation from step ST103 to step ST108 until the control signal is output from the pattern comparing section 73 at step ST106.

As described above, the storage medium changer of the embodiment 1 is configured in such a manner as to check whether the target pattern is detected at the stopping position or not after the stocker driving motor 4 stops, and to set the applied voltage to the stocker driving motor 4 at the lower level to reduce the driving force when retrying by reversing the rotation of the stocker driving motor 4 because the target pattern is not detected at the stopping position. Therefore it has an advantage of being able to stop the stocker elevating section 3 accurately at the changing position because of the reduction in the operation speed of the stocker elevating section 3, and to prevent the operation delay because of the occurrence of the retrying operation a plurality of times. In addition, since the applied voltage to the stocker driving motor 4 is set at the lower level only at the time of retrying, it has an advantage of preventing the changing operation of the disk 2 from being delayed.

### Embodiment 2

In the present embodiment 2, a configuration will be described which reduces the driving force of the stocker driving motor 4 using PWM (Pulse Width Modulation) control at the time of retrying, thereby reducing the operation speed of the stocker elevating section 3. Here, the configuration of the storage medium changer of the embodiment 2 differs from that of the embodiment 1 in that the motor voltage control section 77 and the voltage variable circuit 9 are not required because it is not necessary to carry out the voltage control with an external circuit, and that the motor control section 76 carries out the PWM control. Since the remaining configuration is the same as that of the embodiment 1, the description thereof is omitted here.

Next, the operation will be described.

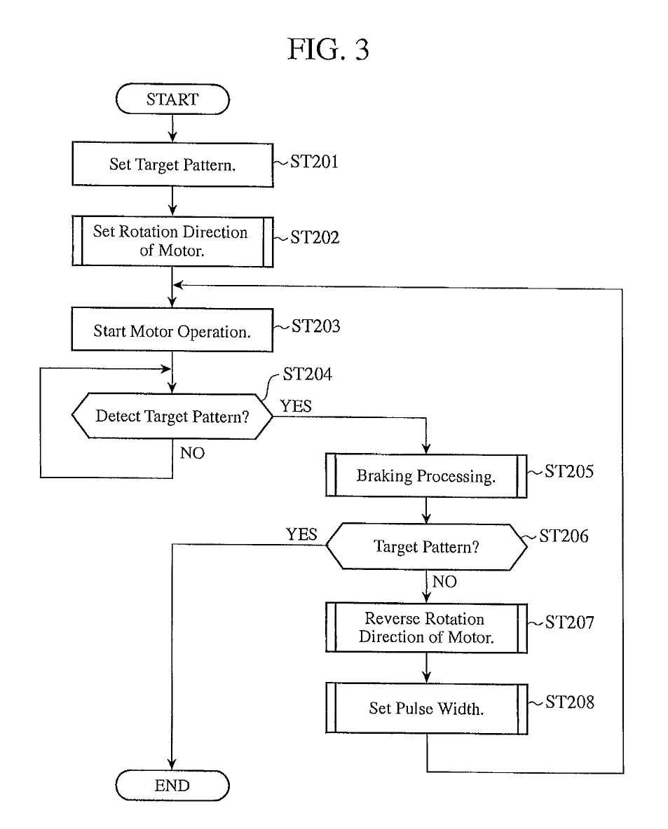

FIG. 3 is a flowchart showing the operation of the storage medium changer of the present embodiment 2. When the external I/F 74 receives a request for changing the disk 2, the mechanism control section 75 refers to the memory 72 in response to the change request received, and sets the pattern of the slit of the position detecting section 5, which will be detected when the stocker elevating section 3 moves to the changing position of the disk 2 for which a request for changing is made, as a target pattern (step ST201). Next, the mechanism control section 75 sets the direction of rotation of the stocker driving motor 4 in accordance with the slit pattern the pattern recognition section 71 recognizes and the target pattern set at step ST201 (step ST202).

Next, the mechanism control section 75 instructs the motor control section 76 to drive the stocker driving motor 4, and the motor control section 76 starts the operation of the stocker driving motor 4 in response to the instruction from the mechanism control section 75 (step ST203). The pattern comparing section 73 compares, throughout the operation of the stocker driving motor 4, the slit pattern recognized by the pattern recognition section 71 with the target pattern, and outputs the control signal when detecting the target pattern (step ST204). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST205) to stop the stocker driving motor 4.

Next, the mechanism control section 75 checks, at the position where the stocker driving motor 4 stops, whether the control signal is output from the pattern comparing section 73 (step ST206). If the control signal is output from the pattern comparing section 73 at step ST206, the mechanism control section 75 completes its operation. Unless the control signal is output from the pattern comparing section 73 at step ST206, the mechanism control section 75 considers that the stocker elevating section 3 overruns the position of the target pattern set at step ST201, reverses the direction of rotation of the stocker driving motor 4 (step ST207), sets the pulse width to reduce the driving force of the stocker driving motor 4 (step ST208) then repeats the operation from step ST203 again, and repeats the operation from step ST203 to step ST208 until the control signal is output from the pattern comparing section 73 at step ST206.

As described above, the storage medium changer of the embodiment 2 is configured in such a manner as to reduce the driving force of the stocker driving motor 4 by the PWM control, thereby reducing the operation speed of the stocker elevating section 3. Therefore it offers an advantage of being able to reduce the operation speed of the stocker elevating section 3 easily. In addition, it offers an advantage of being able to simplify the circuit configuration because it obviates the need for the motor voltage control section 77 and voltage variable circuit 9. The remaining advantages are the same as those of the embodiment 1.

### Embodiment 3

In the present embodiment 3, a configuration will be described which alters the driving force by varying the voltage applied to the stocker driving motor 4 in accordance with the number of disks 2 contained in the disk stocker 1, thereby always operating the stocker elevating section 3 at a constant speed. Here, the storage medium changer of the embodiment 3 is characterized by having a disk detecting section (storage medium detecting section) 10 for detecting how many disks 2 are contained in the disk stocker 1 as shown by broken lines in FIG. 1, and by varying the driving force of the stocker driving motor 4 according to the number of disks 2 detected by the disk detecting section 10. In addition, the memory 72 stores a reference value (referred to as “the reference number” from now on) for varying the driving force of the stocker driving motor 4. As the reference number, for example, it is possible to use half the maximum containing capacity of the disk stocker 1. Since the remaining configuration is the same as that of the embodiment 1, the description thereof is omitted here.

Next, the operation will be described.

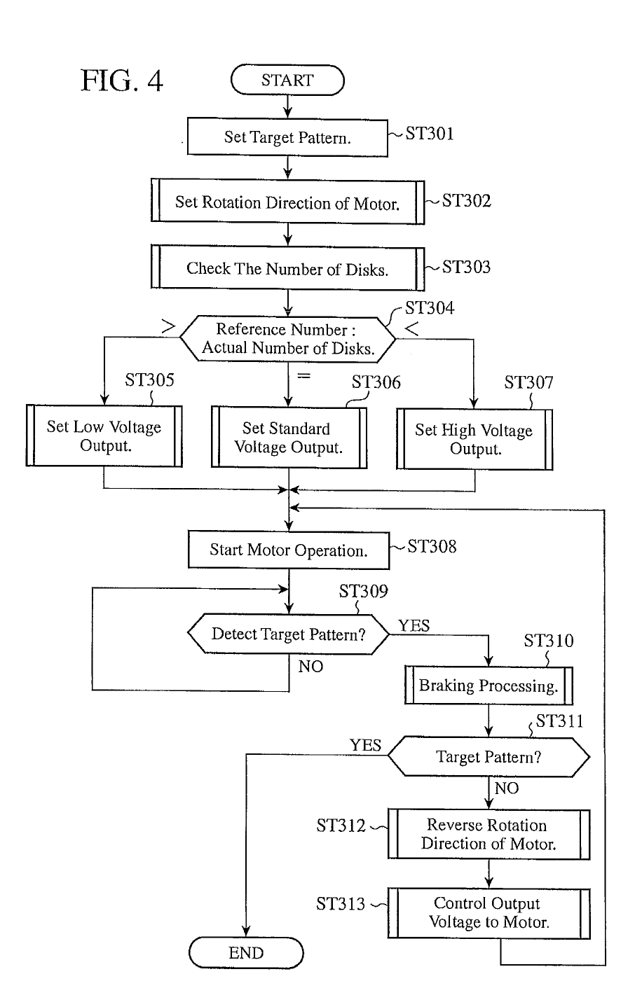

FIG. 4 is a flowchart showing the operation of the storage medium changer of the present embodiment 3. When the external I/F 74 receives a request for changing the disk 2, the mechanism control section 75 refers to the memory 72 in response to the change request received, and sets the pattern of the slit of the position detecting section 5, which will be detected when the stocker elevating section 3 moves to the changing position of the disk 2 for which a request for changing is made, as a target pattern (step ST301). Next, the mechanism control section 75 sets the direction of rotation of the stocker driving motor 4 in accordance with the slit pattern the pattern recognition section 71 recognizes and the target pattern set at step ST301 (step ST302). Next, the mechanism control section 75 checks the number of disks 2 detected by the disk detecting section 10 (step ST303), and compares the number of disks 2 detected by the disk detecting section 10 with the reference number stored in the memory 72 (step ST304).

Next, when the number of disks 2 detected by the disk detecting section 10 is less than the reference number stored in the memory 72, the mechanism control section 75 sets the voltage to be applied to the stocker driving motor 4 at a level lower than the predetermined voltage at normal times (referred to as “standard voltage” from now on) (step ST305). In addition, when the number of disks 2 detected by the disk detecting section 10 is equal to the reference number stored in the memory 72, the mechanism control section 75 sets the voltage to be applied to the stocker driving motor 4 at the standard voltage (step ST306). Furthermore, when the number of disks 2 detected by the disk detecting section 10 is greater than the reference number stored in the memory 72, the mechanism control section 75 sets the voltage to be applied to the stocker driving motor 4 at a level higher than the standard voltage (step ST307).

Next, the mechanism control section 75 instructs the motor control section 76 to drive the stocker driving motor 4 with the voltage set according to the comparison result at step ST304, and the motor control section 76 starts the operation of the stocker driving motor 4 in response to the instruction from the mechanism control section 75 (step ST308). Next, the pattern comparing section 73 compares, throughout the operation of the stocker driving motor 4, the slit pattern recognized by the pattern recognition section 71 with the target pattern, and outputs the control signal when detecting the target pattern (step ST309). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST310) to stop the stocker driving motor 4.

Next, the mechanism control section 75 checks, at the position where the stocker driving motor 4 stops, whether the control signal is output from the pattern comparing section 73 (step ST311). If the control signal is output from the pattern comparing section 73 at step ST311, the mechanism control section 75 completes its operation. Unless the control signal is output from the pattern comparing section 73 at step ST311, the mechanism control section 75 considers that the stocker elevating section 3 overruns the position of the target pattern set at step ST301, reverses the direction of rotation of the stocker driving motor 4 (step ST312), sets the applied voltage at a lower level (step ST313), then repeats the operation from step ST308 again, and repeats the operation from step ST308 to step ST313 until the control signal is output from the pattern comparing section 73 at step ST311.

As described above, the storage medium changer of the embodiment 3 is configured in such a manner as to include the disk detecting section 10 for detecting how many disks 2 are contained in the disk stocker 1, and to vary the driving force by altering the voltage applied to the stocker driving motor 4 depending on the number of disks 2 detected by the disk detecting section 10. As a result, it offers an advantage of being able to always operate the stocker elevating section 3 at a constant speed. As for the other advantages, they are the same as those of the embodiment 1.

### Embodiment 4

In the embodiment 3, although the configuration is described which varies the driving force by altering the voltage applied to the stocker driving motor 4, in the present embodiment 4, a configuration will be described which controls the driving force of the stocker driving motor 4 using the PWM control as in the embodiment 2. Here, the configuration of the storage medium changer of the embodiment 3 differs from that of the embodiment 3 in that the motor voltage control section 77 and the voltage variable circuit 9 are not required because it is not necessary to carry out the voltage control with an external circuit, and that the motor control section 76 carries out the PWM control. Since the remaining configuration is the same as that of the embodiment 3, the description thereof is omitted here.

Next, the operation will be described.

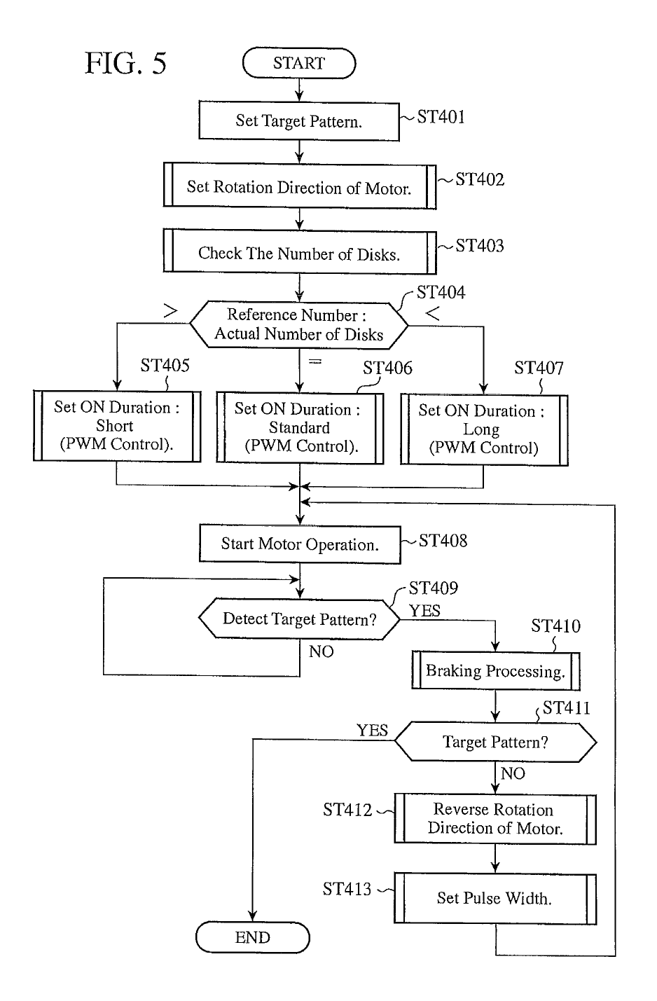

FIG. 5 is a flowchart showing the operation of the storage medium changer of the present embodiment 4. When the external I/F 74 receives a request for changing the disk 2, the mechanism control section 75 refers to the memory 72 in response to the change request received, and sets the pattern of the slit of the position detecting section 5, which will be detected when the stocker elevating section 3 moves to the changing position of the disk 2 for which a request for changing is made, as a target pattern (step ST401). Next, the mechanism control section 75 sets the direction of rotation of the stocker driving motor 4 in accordance with the slit pattern the pattern recognition section 71 recognizes and the slit pattern set at step ST401 (step ST402). Next, the mechanism control section 75 checks the number of disks 2 detected by the disk detecting section 10 (step ST403), and compares the number of disks 2 detected by the disk detecting section 10 with the reference number stored in the memory 72 (step ST404).

Next, when the number of disks 2 detected by the disk detecting section 10 is less than the reference number stored in the memory 72, the mechanism control section 75 instructs the motor control section 76 to set the pulse width in such a manner that the duration in which the voltage is applied to the stocker driving motor 4 becomes shorter than predetermined duration at normal times (referred to as “standard duration” from now on) (step ST405). In addition, when the number of disks 2 detected by the disk detecting section 10 is equal to the reference number stored in the memory 72, the mechanism control section 75 instructs the motor control section 76 to set the pulse width in such a manner that the duration in which the voltage is applied to the stocker driving motor 4 becomes the standard duration (step ST406). Furthermore, when the number of disks 2 detected by the disk detecting section 10 is greater than the reference number stored in the memory 72, the mechanism control section 75 instructs the motor control section 76 to set the pulse width in such a manner that the duration in which the voltage is applied to the stocker driving motor 4 becomes longer than the standard duration (step ST407).

Next, the mechanism control section 75 instructs the motor control section 76 to drive the stocker driving motor 4 with the pulse width set according to the comparison result at step ST404, and the motor control section 76 starts the operation of the stocker driving motor 4 based on the PWM control in response to the instruction from the mechanism control section 75 (step ST408). Next, the pattern comparing section 73 compares, throughout the operation of the stocker driving motor 4, the slit pattern recognized by the pattern recognition section 71 with the target pattern, and outputs the control signal when detecting the target pattern (step ST409). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST410) to stop the stocker driving motor 4.

Next, the mechanism control section 75 checks, at the position where the stocker driving motor 4 stops, whether the control signal is output from the pattern comparing section 73 (step ST411). If the control signal is output from the pattern comparing section 73 at step ST411, the mechanism control section 75 completes its operation. Unless the control signal is output from the pattern comparing section 73 at step ST411, the mechanism control section 75 considers that the stocker elevating section 3 overruns the position of the target pattern set at step ST401, reverses the direction of rotation of the stocker driving motor 4 (step ST412), instructs the motor control section 76 to set the pulse width in such a manner that the voltage applying duration to the stocker driving motor 4 becomes shorter to further reduce the driving force of the stocker driving motor 4 (step ST413), repeats the operation from step ST408 again, and repeats the operation from step ST408 to step ST413 until the control signal is output from the pattern comparing section 73 at step ST411.

As described above, since the storage medium changer of the embodiment 4 is configured in such a manner as to vary the driving force of the stocker driving motor 4 by the PWM control, it offers an advantage of being able to alter the driving force of the stocker driving motor 4 easily. In addition, it offers an advantage of being able to simplify the circuit configuration because it can obviate the need for the motor voltage control section 77 and the voltage variable circuit 9. The other advantages are the same as those of embodiment 3.

### Embodiment 5

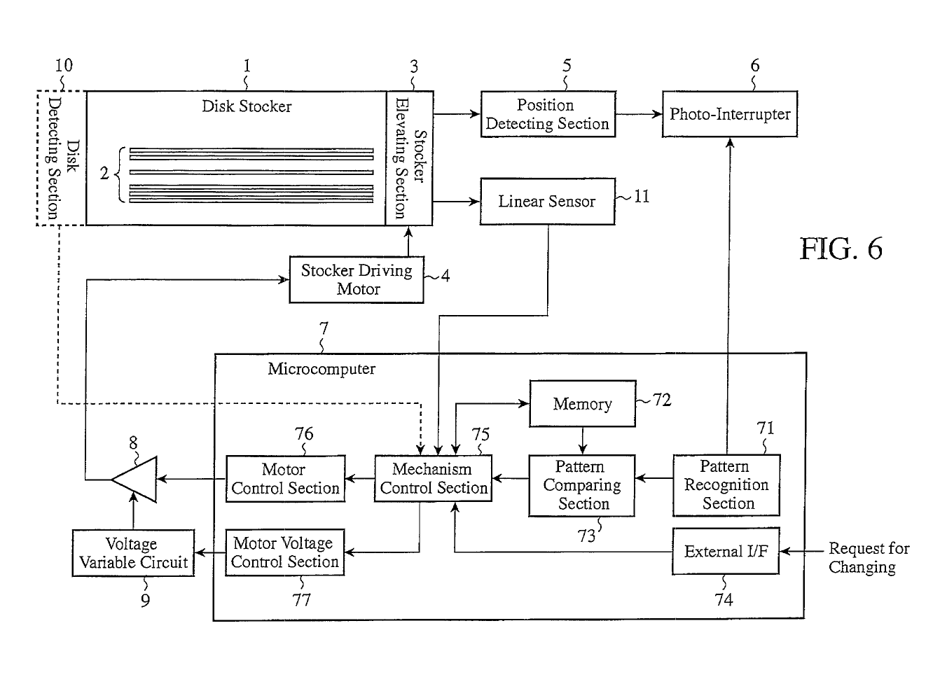

FIG. 6 is a block diagram showing a configuration of the storage medium changer of an embodiment 5. The storage medium changer of the embodiment 5 has a linear sensor 11 for detecting the current position of the stocker elevating section 3 and producing a signal corresponding to the position. Thus, it can recognize the current position of the stocker elevating section 3 from the output signal of the linear sensor 11. The mechanism control section 75 is characterized by detecting from the output signal of the linear sensor 11 that the stocker elevating section 3 approaches the changing position of the disk 2 for which a request for changing is made; by reducing the driving force of the stocker driving motor 4 at a position before the changing position (referred to as “deceleration position” from now on); and by slowing down the operation speed of the stocker elevating section 3. Since the remaining configuration is the same as that of the embodiment 1, the description thereof is omitted.

Next, the operation will be described.

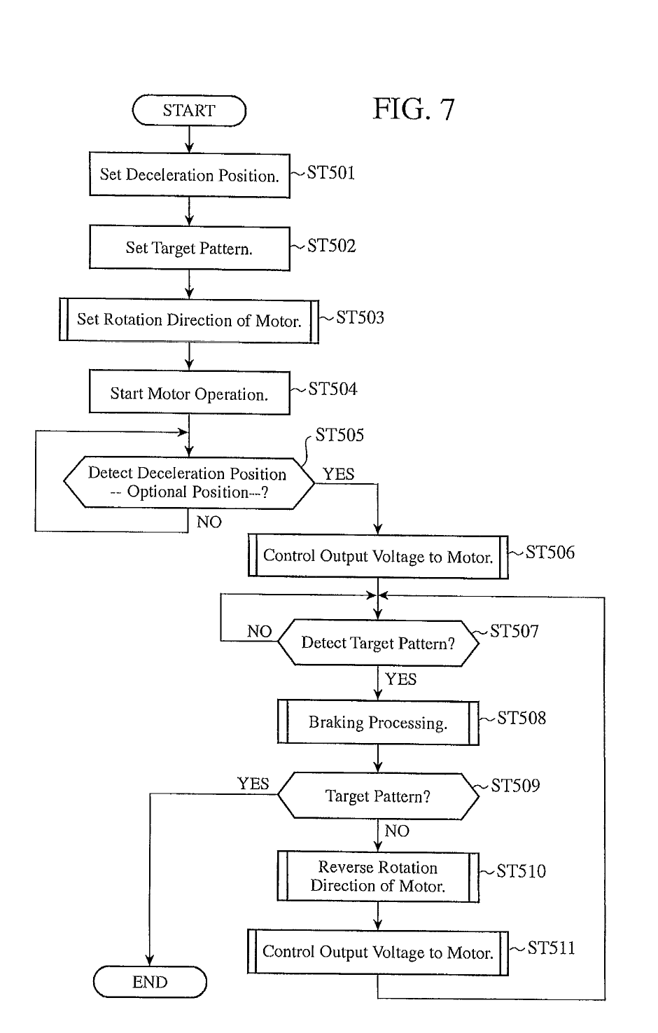

FIG. 7 is a flowchart showing the operation of the storage medium changer of the present embodiment 5. When the external I/F 74 receives a request for changing the disk 2, the mechanism control section 75 sets the deceleration position at which it reduces the applied voltage to the stocker driving motor 4 in response to the change request received (step ST501). Next, the mechanism control section 75 refers to the memory 72, and sets the pattern of the slit of the position detecting section 5, which will be detected when the stocker elevating section 3 moves to the changing position of the disk 2 for which a request for changing is made, as a target pattern (step ST502). Next, the mechanism control section 75 sets the direction of rotation of the stocker driving motor 4 in accordance with the slit pattern the pattern recognition section 71 recognizes and the target pattern set at step ST502 (step ST503).

Next, the mechanism control section 75 instructs the motor control section 76 to drive the stocker driving motor 4, and the motor control section 76 starts the operation of the stocker driving motor 4 in response to the instruction from the mechanism control section 75 (step ST504). The mechanism control section 75 always monitors the output signal from the linear sensor 11 during the operation of the stocker driving motor 4, and checks whether the stocker elevating section 3 reaches the deceleration position set at step ST501, that is, whether the mechanism control section 75 detects the deceleration position or not (step ST505). When detecting that the stocker elevating section 3 reaches the deceleration position from the output signal from the linear sensor 11, the mechanism control section 75 sets the applied voltage to the stocker driving motor 4 at a low level (step ST506) to reduce the driving force of the stocker driving motor 4, thereby slowing down the operation speed of the stocker elevating section 3.

Next, the pattern comparing section 73 compares the slit pattern recognized by the pattern recognition section 71 with the target pattern, and outputs the control signal when detecting the target pattern (step ST507). When the pattern comparing section 73 outputs the control signal, the mechanism control section 75 instructs the motor control section 76 to stop the operation of the stocker driving motor 4, and the motor control section 76 carries out the braking processing of the stocker driving motor 4 in response to the instruction from the mechanism control section 75 (step ST508) to stop the stocker driving motor 4.

Next, the mechanism control section 75 checks, at the position where the stocker driving motor 4 stops, whether the control signal is output from the pattern comparing section 73 (step ST509). If the control signal is output from the pattern comparing section 73 at step ST509, the mechanism control section 75 completes its operation. Unless the control signal is output from the pattern comparing section 73 at step ST509, the mechanism control section 75 considers that the stocker elevating section 3 overruns the position of the target pattern set at step ST502, reverses the direction of rotation of the stocker driving motor 4 (step ST510), sets the applied voltage at a lower level (step ST511), then repeats the operation from step ST507 again, and repeats the operation from step ST507 to step ST511 until the control signal is output from the pattern comparing section 73 at step ST509.

As described above, the storage medium changer of the embodiment 5 is configured in such a manner as to include the linear sensor 11 for detecting the current position of the stocker elevating section 3; to detect from the output signal from the linear sensor 11 that the stocker elevating section 3 approaches the changing position of the disk 2 for which a request for changing is made; and to slow down the operation speed of the stocker elevating section 3 by reducing the driving force of the stocker driving motor 4 at the deceleration position before the changing position. Thus, it offers an advantage of being able to reduce the number of times of the retrying operation. As for the other advantages, they are the same as those of the embodiment 1.

Incidentally, although the embodiment 5 decreases the driving force of the stocker driving motor 4 by reducing the applied voltage to the stocker driving motor 4, it is also possible to decrease the driving force of the stocker driving motor 4 by the PWM control as the embodiment 2. In addition, as in the embodiment 3 or 4, it is also possible to include the disk detecting section 10 for detecting how many disks 2 are contained in the disk stocker 1; to store the reference value for altering the driving force of the stocker driving motor 4 in the memory 72; and to vary the driving force of the stocker driving motor 4 in accordance with the number of disks 2 contained in the disk stocker 1.

### INDUSTRIAL APPLICABILITY

As described above, the storage medium changer in accordance with the present invention can stop the stocker elevating section, which moves up and down the stocker containing the storage mediums, at the prescribed position accurately, and can prevent the delay due to the retrying operation. Accordingly, it is suitable for CD changers and the like.

What is claimed is:

1. A storage medium changer comprising:
a stocker for containing storage mediums;
a stocker elevating section for moving the stocker up and down;
a stocker driving motor for driving the stocker elevating section;
a position detecting section having a slit whose pattern varies in accordance with a position of the stocker elevating section;
a slit detecting section for optically detecting the pattern of the slit of the position detecting section;
a pattern recognition section for recognizing the pattern of the slit output from the slit detecting section;
a memory for storing the pattern of the slit of the position detecting section and the position of the stocker elevating section with correspondence between them;
a pattern comparing section for comparing, referring to the memory when a request for changing a storage medium occurs, the pattern of the slit, which will be detected when the stocker elevating section moves to the changing position of the storage medium for which the request for changing is made, with the pattern of the slit the pattern recognition section recognizes, and for outputting a control signal when a target pattern is detected;
a mechanism control section for instructing to stop the operation of the stocker driving motor when the pattern comparing section outputs the control signal, and for instructing, to carry out the operation of the stocker driving motor again after reversing a direction of rotation of the stocker driving motor and setting a driving force of the stocker driving motor at a lower level when the control signal is not output from the pattern comparing section at the stopping position; and
a motor control section for controlling the stocker driving motor in response to the instruction of the mechanism control section.

2. The storage medium changer according to claim 1, further comprising:
a storage medium detecting section for detecting the number of the storage mediums contained in the stocker, wherein
the mechanism control section varies the driving force of the stocker driving motor in accordance with the number of the storage mediums detected by the storage medium detecting section.

3. The storage medium changer according to claim 1, further comprising:
a linear sensor for detecting the position of the stocker elevating section, and for outputting a signal corresponding to the position, wherein
the mechanism control section detects, from an output signal from the linear sensor, that the stocker elevating section approaches the changing position, and sets the driving force of the stocker driving motor at a lower level before the changing position.

4. The storage medium changer according to claim 1, wherein
the motor control section reduces the driving force of the stocker driving motor by controlling applied voltage.

5. The storage medium changer according to claim 1, wherein
the motor control section reduces the driving force of the stocker driving motor by PWM control.
